(19) United States
(12) Patent Application Publication
(10) Pub. No.: US 2025/0091178 A1
(43) Pub. Date: Mar. 20, 2025

(54) MODULAR CLAMP SYSTEM

(71) Applicant: David Bowers, Flemington, NJ (US)

(72) Inventor: David Bowers, Flemington, NJ (US)

(21) Appl. No.: 18/889,446

(22) Filed: Sep. 19, 2024

Related U.S. Application Data
(60) Provisional application No. 63/539,114, filed on Sep. 19, 2023.

(51) Int. Cl. B25B 5/16; B25B 5/10

(52) U.S. Cl. CPC B25B 5/166; B25B 5/101

(57) ABSTRACT

A modular clamp system includes at least one clamp having an L-shaped clamp body. The clamp body is defined by a first leg and a second leg, where the first leg includes a threaded bore extending therethrough, while the second leg includes a threaded channel in which a spring loaded retractable pin is retained. The clamp may further include a handle assembly having an adjustable threaded rod configured to travel back and forth through the threaded bore and to engage a workpiece. The handle assembly has a handle for rotating the handle assembly and may include a hex cap to interface with a drill or wrench. The clamp also includes a pair of spaced apart cleated feet for securing the clamp to a framing such as a half-slotted strut.

### CLAIM OF PRIORITY

This application claims priority to U.S. Application Ser. No. 63/539,114 filed on Sep. 19, 2023, the contents of which are hereby fully incorporated by reference in its entirety.

### FIELD OF THE EMBODIMENTS

The present disclosure relates to clamps, clamping systems, and methods of using clamps.

### BACKGROUND OF THE EMBODIMENTS

A clamp is a handy tool used to hold a workpiece securely in place while working. Applications for which a clamp can be used include: woodworking and carpentry, painting, and metalworking. For example, a clamp can be used to hold a piece of wood to a workbench, or to perform a variety of woodworking tasks, such as sawing or chasing. A clamp is also a useful tool for holding a workpiece steady while painting. For applications such as welding, grinding, or manufacturing, a clamp is an ideal tool to use to hold metals of all types, including steel, iron, aluminum, and Copper.

Clamps hold objects firmly in place. Whether it is used to clamp an object to a work surface or to hold two or more objects together, the purpose of clamps is to provide the user with a firm grip to accomplish a required task. If a clamp has only one jaw, then the device is designed to be used in conjunction with a work surface, such as a benchstop to stabilize an object. However, if a clamp has two jaws, they will work together to hold an item.

Depending on the mechanism used, the jaws are controlled differently on different types of clamps. Some types will use a trigger mechanism, whereby the jaws are adjusted using a trigger or lever. Alternatively, some types have a conventional screw that adjusts the clamp. When the screw is rotated, the clamps close around the workpiece, and pressures are applied to keep it firmly in place.

There are many different types of clamps, with the most common being the C-clamp. The ‘C’ part of the clamps goes around a work surface and an object to be clamped, while a long screw is turned to tighten the jaws and make the clamp secure. These types of clamps are quite popular and are used for a variety of jobs. There are also various designs of C clamps that are available for a variety of job requirements, such as standard C-Clamp, double anvil C-clamp for even load distribution, quick release C-clamp for fast action, copper coated C-clamp used to prevent weld spatter build-up, and deep reach c-clamps used for long reach. In addition to C-clamps there are many other types of clamps used for different purposes. However, there is no one clamp that is versatile enough to address a wide variety of clamping needs.

### SUMMARY OF THE EMBODIMENTS

A modular clamp system includes at least one clamp, but preferably a pair of movable clamps that easily attach to framing such as half-slotted strut®. The clamp includes an L-shaped clamp body having a first and second leg. The first leg has a threaded bore slightly below an end of the leg which is configured to receive a threaded member such as adjustment screw or threaded handle assembly described more fully below. The second leg includes a threaded channel in which a spring loaded retractable pin is retained. The spring loaded retractable pin is used in conjunction with a pair of cleated feet to help secure the clamp body to half-slotted strut.

The handle assembly includes a threaded rod and a handle for rotating the threaded rod about a longitudinal axis extending through the threaded rod. A hex cap is attached to a terminal end of the threaded rod, adjacent to the handle and a removable end pad is attached to the threaded rod at an opposite end from the hex cap.

A pair of spaced apart cleated feet extend from a base of the clamp body. The cleated feet are each disposed on opposite sides of the base. The cleated feet are dimensioned to be inserted into corresponding openings in a surface of a framing such as half-slotted strut framing or strut channel, and are configured to hook around an opposite side surface of the framing. When the cleated feet are inserted through the openings, the spring loaded pin may compress on the surface of the framing. A set screw overlying the spring loaded pin can then be tightened, to further compress the spring loaded pin against the framing surface. The framing surface is thus clamped between the cleated feet, the clamp body base, and the spring loaded pin.

The threaded bore is configured to receive the threaded portion (i.e., the threaded rod) of the handle assembly which rotatably engages the threaded bore and advances or retracts through the bore upon being rotated therein. The handle assembly provides the clamping action by advancing through the threaded bore until the end pad presses firmly against a workpiece that is trapped between the end pad and another surface.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of different configurations of the modular clamp system in accordance with an embodiment of the present invention.

FIG. 2 is a partial perspective view of the modular clamp system of FIG. 1 in accordance with an embodiment of the present invention.

FIG. 3A is a perspective view of the clamp body in accordance with an embodiment of the present invention.

FIG. 3B is a sectional view of the clamp body shown in FIG. 3A taken along 3B-3B.

FIG. 4 is a perspective view of the snap-in pad in accordance with an embodiment of the present invention.

FIG. 5 is a perspective view of the handle assembly in accordance with an embodiment of the present invention.

FIGS. 6-7 show side elevation views of different configurations of the clamp in accordance with an embodiment of the present invention.

FIG. 8A is a front elevation view of the clamp of FIG. 6 in accordance with an embodiment of the present invention.

FIG. 8B is a rear elevation view of the clamp of FIG. 6 in accordance with an embodiment of the present invention.

FIG. 9A is a top plan view of the clamp of FIG. 6 in accordance with an embodiment of the present invention.

FIG. 9B is a bottom plan view of the clamp of FIG. 6 in accordance with an embodiment of the present invention.

FIG. 10 is a perspective view of the clamp attached to a half-slotted strut in accordance with an embodiment of the present invention.

FIG. 11 illustrates how the snap-in pad can be inserted into an opening of the threaded bore in accordance with an embodiment of the present invention.

FIG. 12 illustrates how the cleated feet can be inserted into corresponding openings of a half-slotted strut in accordance with an embodiment of the present invention.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, portion, component, region, layer, or section from another element, portion, component, region, layer or section. Thus, “a first element,” “component,” “region,” “portion,” “layer,” or “section” discussed below could be termed a second element, component, region, portion, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

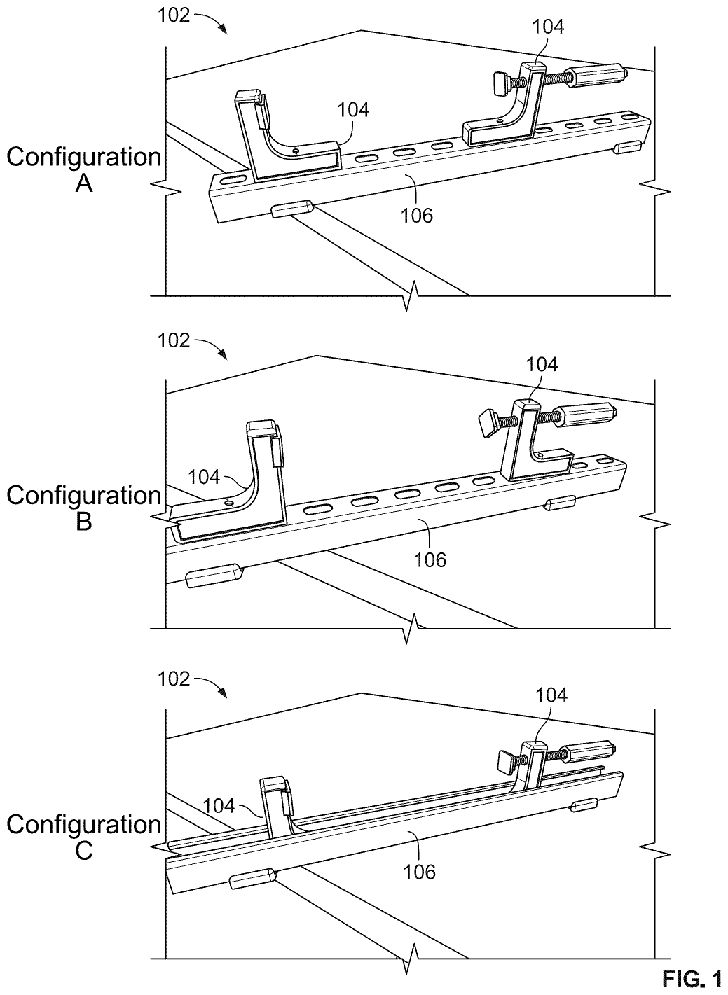

Disclosed in FIG. 1 is a modular clamp system 102 that provides for one or more easy to install clamps 104 that can be moved from one position to another along a framing such as half-slotted strut 106. The modular clamp system 102 provides a secure method of holding an article such as a workpiece. In addition, the one or more clamps 104 can be reversibly attached to the half-slotted strut 106 in various configurations such as front-to-front or front-to-back as shown in the figure. In the front-to-front configuration (configuration A) the clamps mirror each other, while in the back-to-back configuration (configuration B), the back of one clamp faces the back of another clamp. In a third configuration (configuration C), the clamps are front-to-front as in configuration A but are secured inside the channel of the half-slotted strut 106. Of course, other configurations or arrangements of clamps are possible either inside or outside the channel of strut 106, such as front-front, back-to-back, front-to-back, or back-to-front. As shown in FIG. 1, a handle assembly 502 acts like a clamp adjustment screw which can be inserted into a threaded bore 316 of the clamp from either the front or back of clamp 104, allowing for versatility in clamping articles of different sizes and shapes.

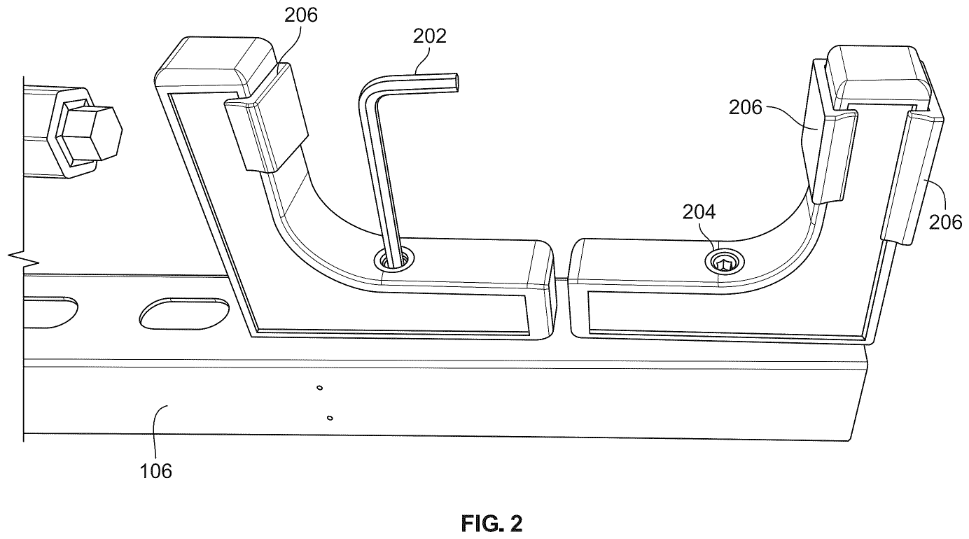

FIG. 2, shows a modular clamp system having two front-to-front clamps facing each other as in configuration A and secured to the outside of the strut channel. As illustrated in the figure, an Allen Wrench 202 may be used to help secure the clamp(s) to the strut by rotating a screw which pushes a spring loaded pin 310 against the strut 106 while clamp feet (not shown in FIG. 2) are anchored in corresponding openings in strut 106. The terms “strut” and half-slotted strut shall be regarded as equivalent terms throughout this application and may be used interchangeably.

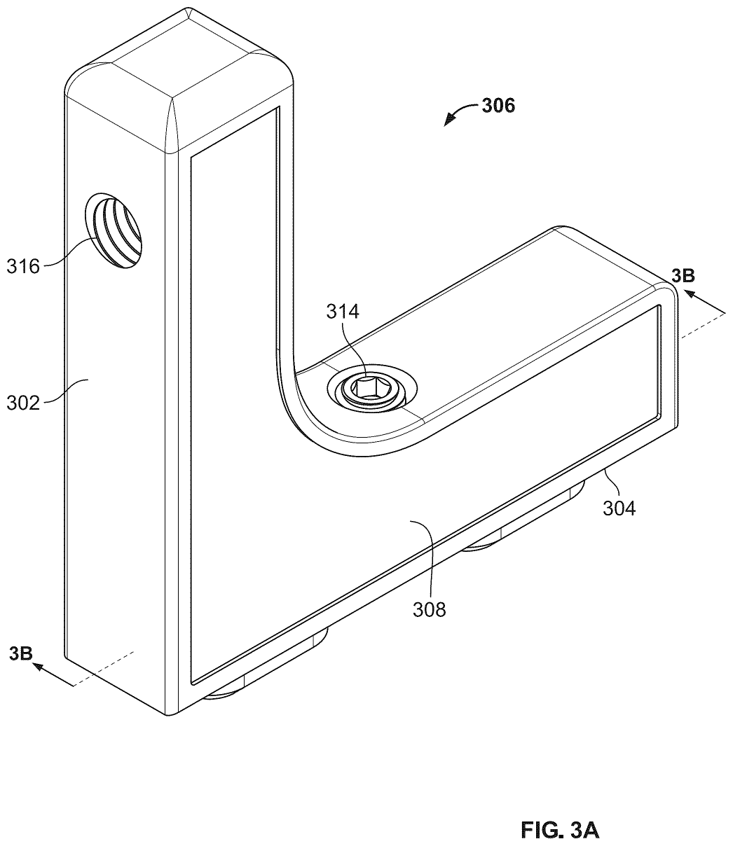

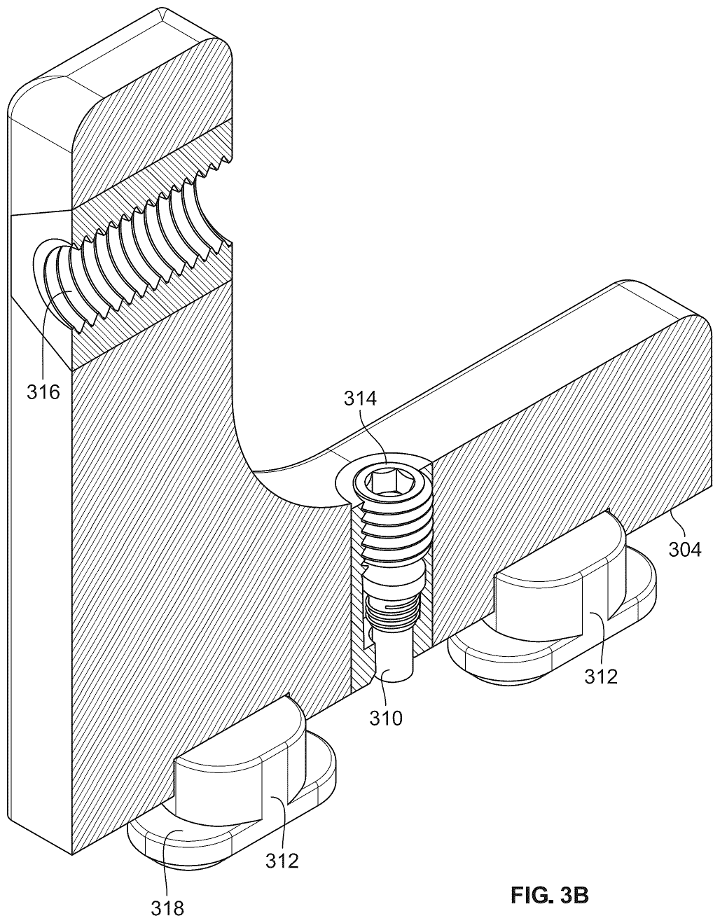

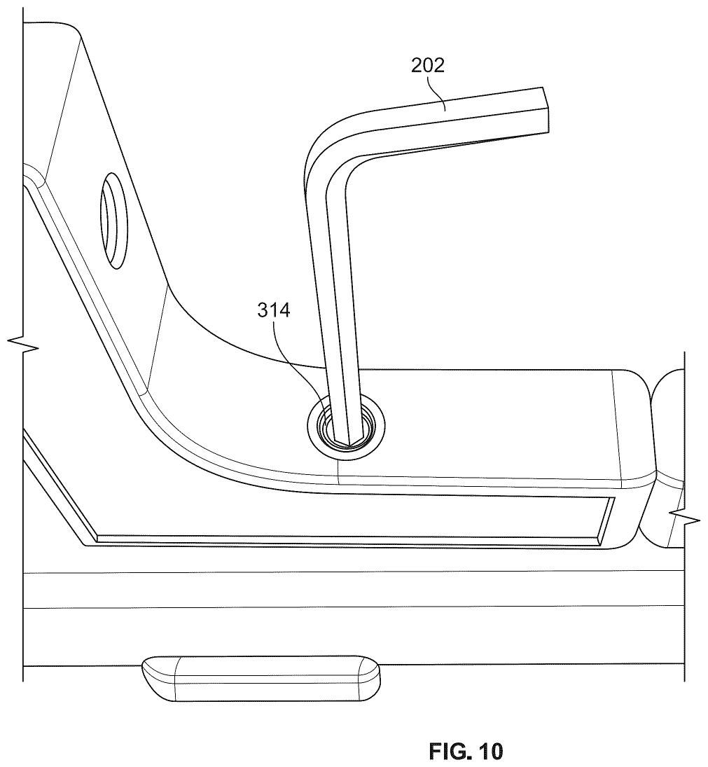

As shown in FIGS. 3A and 3B, the at least one clamp 104 of the modular clamp system 102 includes an L-shaped clamp body 306 having a first leg 302, and a second leg 308. The first leg 302 includes threaded bore 316 extending therethrough, close to an end of the first leg 302. The second leg 308 includes a threaded channel 204 in which a spring-loaded pin 310 is retained. As shown in FIG. 3B, a set screw 314 may be threaded into the threaded channel 204 to compress the spring loaded pin 310 against a surface, such as the surface of the half-slotted strut 106. For example, the spring loaded pin may be used to help clamp the L-shaped clamp body to a segment of half-slotted strut 106 by inserting cleated feet 312 into corresponding openings in the half-slotted strut. Inserting or snapping the cleated feet into the openings causes a base 602 of the clamp body to become flush with a surface of the half-slotted strut 106 and compresses the spring loaded pin 310. When the cleated feet 312 are snapped into the openings, a flanged portion 318 of the cleated feet extend under an opposite side surface of the half-slotted strut to anchor the clamp body to the half-slotted strut 106. The set screw 314 can then be used to further tighten or compress the spring loaded pin 310 against the surface of the half-slotted strut using, for example, an Allen Wrench as shown in FIGS. 2 and 10.

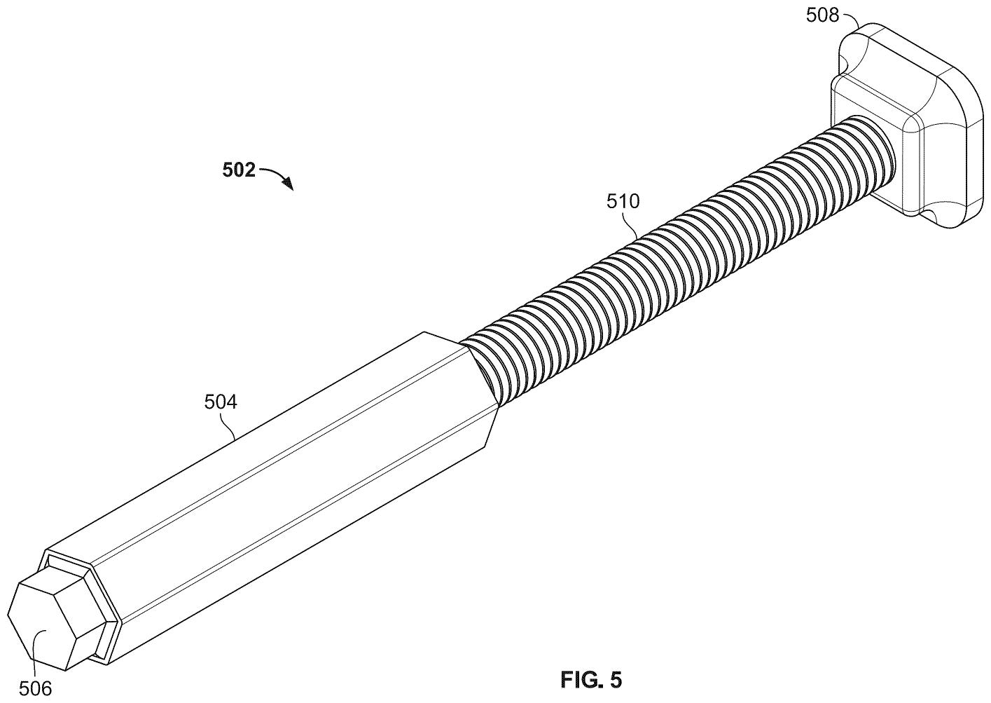

As illustrated in FIGS. 5-7, the handle assembly 502 includes a threaded rod 510 configured to engage complementary threads in the threaded bore 316. A hex handle 504 extends longitudinally over a segment of the threaded rod 510, and preferably has a hexagonal cross-section. However, one of ordinary skill in the art will appreciate that the handle can have a different shaped cross-section such as a circle, square, triangle or any other geometric shape. The hex handle can be rotated manually or mechanically using a wrench (e.g., a socket wrench) or drill with an appropriately sized drill socket.

A hex cap or hex 506 may be attached to a terminal end of the threaded rod 504, adjacent to the hex handle 504. Alternatively, the hex 506 may be an integral part of the hex handle 506 that fits into an appropriately sized socket in order to facilitate mechanical rotation of the handle assembly by a socket wrench or drill/driver.

A removable end pad 508 may be disposed at an opposite end of the handle assembly, opposite from hex 506. The removable end pad 508 serves as a means of clamping an article such as a workpiece by, for example, pressing against the workpiece and trapping the workpiece between the removable end pad 508 and an opposing surface. The opposing surface may be another end pad attached to a handle assembly of a second clamp, a fixed surface on a second clamp, or any other fixed surface.

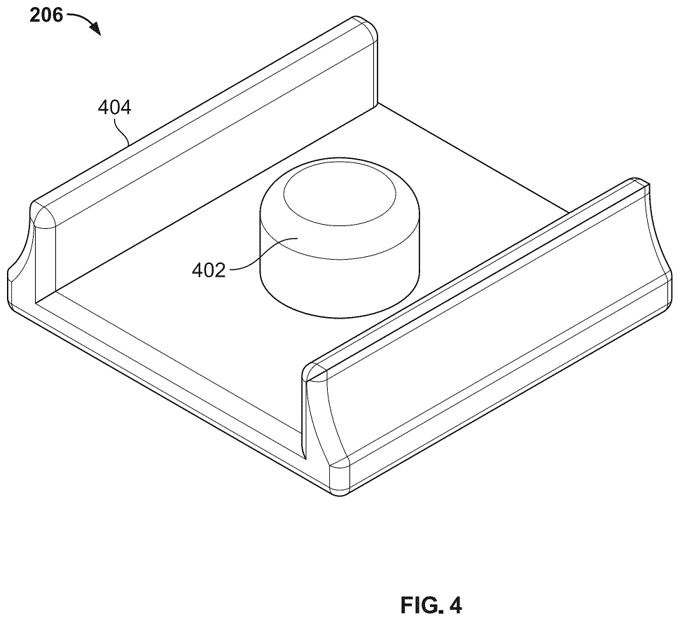

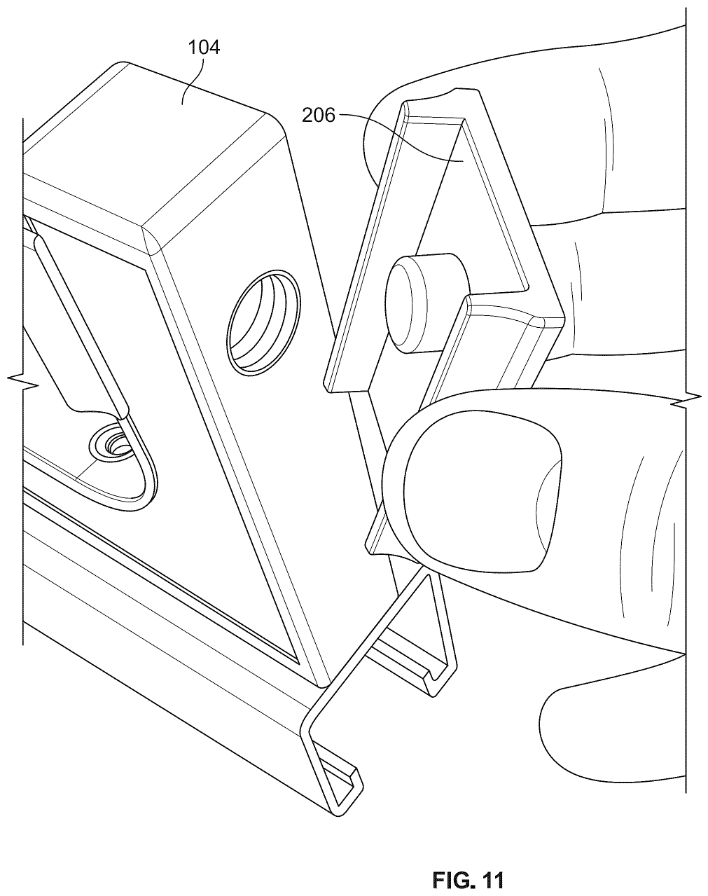

According to the exemplary embodiment illustrated in FIG. 1, the modular clamp system 102 includes a plurality of clamps where different clamps serve different functions. For example, one clamp can serve as a “live end” while another serves as a “dead end.” The live end includes the adjustable handle assembly which provides adjustable clamping action, while the dead end provides an opposing fixed surface, such as a surface formed by snap-in pad 206 shown in FIGS. 4 and 11, covering an opening of the threaded bore 316. The snap-in pad 206 may include a stud 402 and wings 404 configured to grip the sides of the first leg of the clamp body. The pad 206 may be snapped into the threaded bore 316 by inserting the stud 402 into an opening of the threaded bore 316 causing the wings 404 to grip the sides of the clamp body.

As shown in FIGS. 3A and 3B, a pair of spaced apart cleated feet 312 extend from a base 304 of the clamp 104. The cleated feet 312 are disposed on opposite sides of the clamp base 304 and are used to secure the clamp to framing such as half-slotted strut 106. Specifically, the cleated feet 312 are configured to be inserted through corresponding openings in a surface of the half-slotted strut 106. A flanged portion 318 of each of the cleated feet hooks under the opposite side surface of the half-slotted strut 106 thus trapping the half-slotted strut between the flanged portion 318 and the base 304 of the clamp. In an alternate embodiment, the cleated feet 312 may be secured to the base 304 of the clamp by means of an adjustable screw that threads into corresponding threaded openings in the base. In other embodiments, the cleated feet 312 are height adjustable via threading and may be rotated clockwise or counterclockwise to modify a distance from an underside of the clamp 104 to a bottom of the cleated feet 312. This allows for various struts 106 to be used as well as provide additional flexibility in how the cleated feet 312 are secure to the strut 106.

The threaded bore 316 is configured to receive the threaded rod 510 of the handle assembly 502 which rotatably engages complementary threads in the threaded bore 316 and advances or retracts through the bore upon being rotated therein. As discussed above, the handle assembly 502 may include a removable end pad 508 attached at one end having a flat contact surface that can be firmly pressed against an article. In one embodiment, the removable end pad 508 may be snapped on/off from an end of the threaded rod 510. One of ordinary skill in the art will appreciate that the removable end pad 508 may have a different shape or dimension depending on the workpiece being clamped. In addition, the removable end pad may include a hard or soft surface made of rubber, plastic, fabric, wood, metal, ceramic, glass, stone, or any other material. The surface of removable end pad may be smooth, contoured, bumpy, prickly, grooved, sticky, include an adhesive, include one or more suction cups, or be covered with a Velcro® (hook and loop) material. One of ordinary skill in the art will further appreciate that any part of the modular clamp system described herein may be made of any of the materials listed above or any other suitable material.

As mentioned above, the opposite end of the handle assembly (i.e., the end opposite the removable end pad) may include a hex cap 506 attached to or integral with the handle assembly 502. The hex cap 506 may serve as an interface for a drill socket or socket wrench thereby facilitating mechanical rotation of the handle assembly.

According to an embodiment, the modular clamp system 102 includes one or more pairs of the herein described clamps where each pair of clamps is used in concert and mounted together on a piece of framing such as a half-slotted strut (sold at Home Depot® under the name “Superstrut”). One clamp in the pair functions as a “dead-end,” with an attachable/detachable pad covering the threaded bore. The other clamp functions as a “live-end,” with the threaded rod portion of the handle assembly screwed into the threaded bore to provide the clamping action. For ease of manufacture, and maximum flexibility, both clamps of the clamping system may be identical, but this is not required. Their function (live-end or dead-end) depends on which attachment is inserted into the threaded bore. When inserted into the half-slotted strut, the cleated feet can be locked into place under clamping pressure. The spring loaded pin can hold each end of the clamps in place, if desired, by using a hex wrench or Allen wrench to turn a set screw, thus pressing the pin into the half-slotted strut, creating sufficient pressure to hold the clamp ends in place. To release the clamps, simply turn the set screw counterclockwise and the spring loaded pin will retract. This clamp system is reversible in any combination and can be mounted inside the channel of the half-slotted strut or on the outside of the half-slotted strut.

A description of each figure will now be provided. FIG. 1 illustrates a perspective view of a modular clamp system 102 showing three different configurations, A, B, and C. Each of the configurations shows a different arrangement of clamps such as front-to-front (configuration A), back-to-back (configuration B) or front-to-front inside a strut channel (configuration C). As previously mentioned, other configurations are possible and configurations A, B, and C are just some examples of ways the clamps can be arranged for different purposes.

FIG. 2 shows a partial perspective view of the modular clamp system 102 shown in FIG. 1. The clamps mirror each other, i.e., the front of each clamp 104 faces each other. In addition, snap-in pads 206 cover openings of the threaded bore 302. A clamp 104 is attached to the half-slotted strut 106 using the cleated feet 312 to clamp onto an opposite side of the half-slotted strut 106. An Allen wrench is used to screw a set screw 314 into the threaded channel 204 above the spring loaded pin 310 in order to compress the spring loaded pin 310 against the half-slotted strut thus creating a tighter clamp around the half-slotted strut to hold live and dead ends in place when handling the clamping system.

FIG. 3A shows a perspective view of a clamp body 306 having an L-shape with a first leg 302 and a second leg 308. A threaded bore 316 extends through the first leg and a threaded channel 204 extends through the second leg. The threaded bore is configured to receive the handle assembly which provides the clamping action, while the threaded channel holds the spring loaded pin which is seated therein. A set screw can be inserted in the threaded channel to help secure the clamp to a framing.

FIG. 3B is a cross-sectional view of the clamp body of FIG. 3A showing the threaded bore and the threaded channel. As shown in the figure, a spring loaded pin sits inside the channel and a set screw sits atop the spring loaded pin. Rotation of the set screw by, for example, a hex wrench, serves to push down on the spring loaded pin.

FIG. 4 illustrates a perspective view of the snap-in pad 206 described above.

FIG. 5 shows a perspective view of the handle assembly 502 described above.

The handle assembly 502 includes a threaded bore 316, a hex handle 504, a removable end pad 508 at one end, and a hex interface 506 at the opposite end.

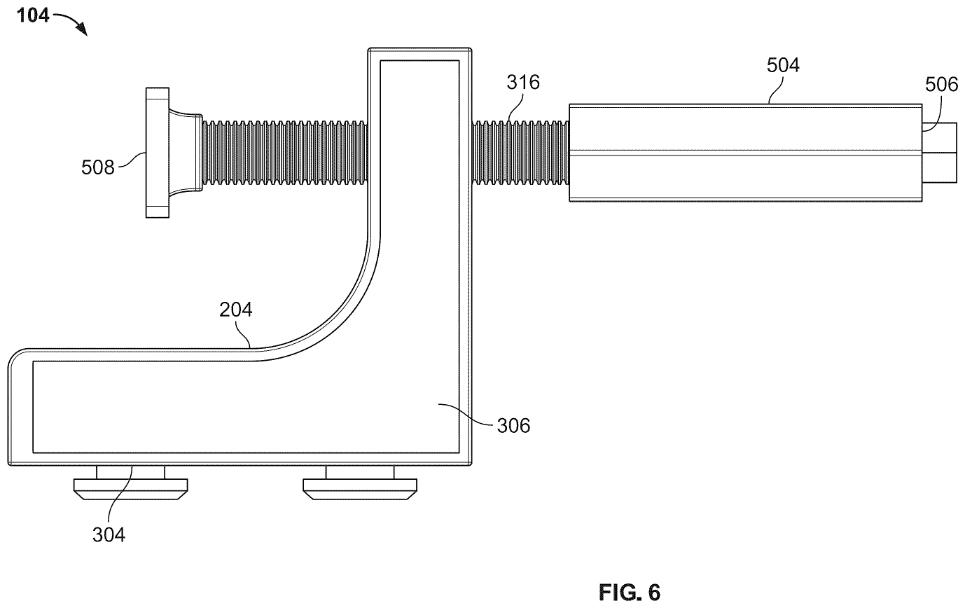

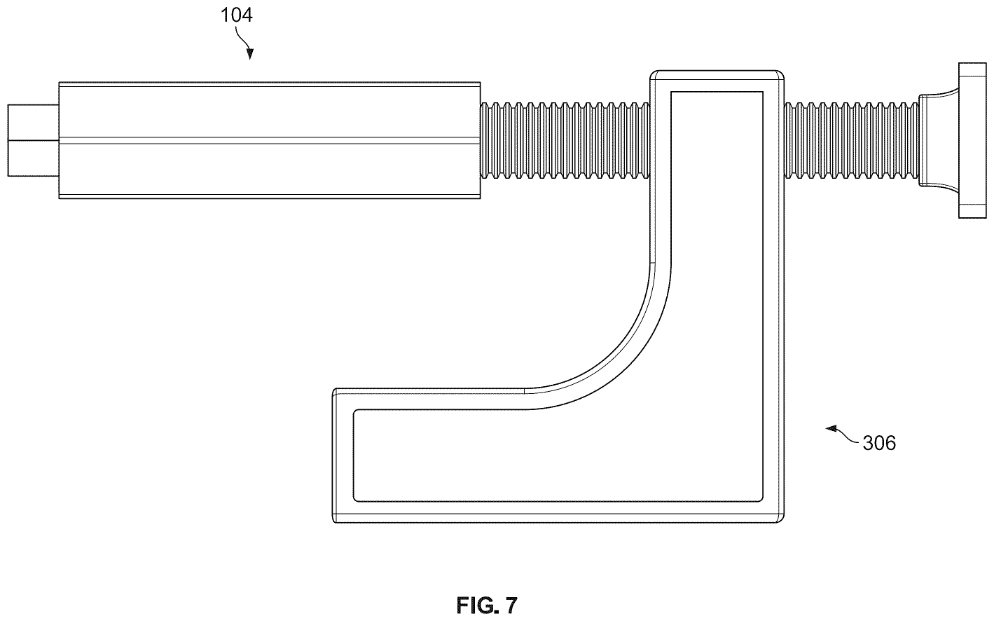

FIGS. 6 and 7 show the clamp with the handle assembly facing in opposite directions.

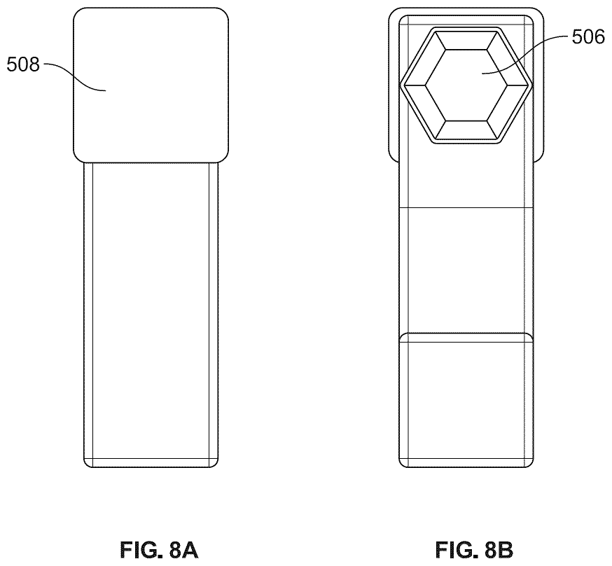

FIG. 8A is a front elevation view of the clamp of FIG. 6.

FIG. 8B is a rear elevation view of the clamp of FIG. 6.

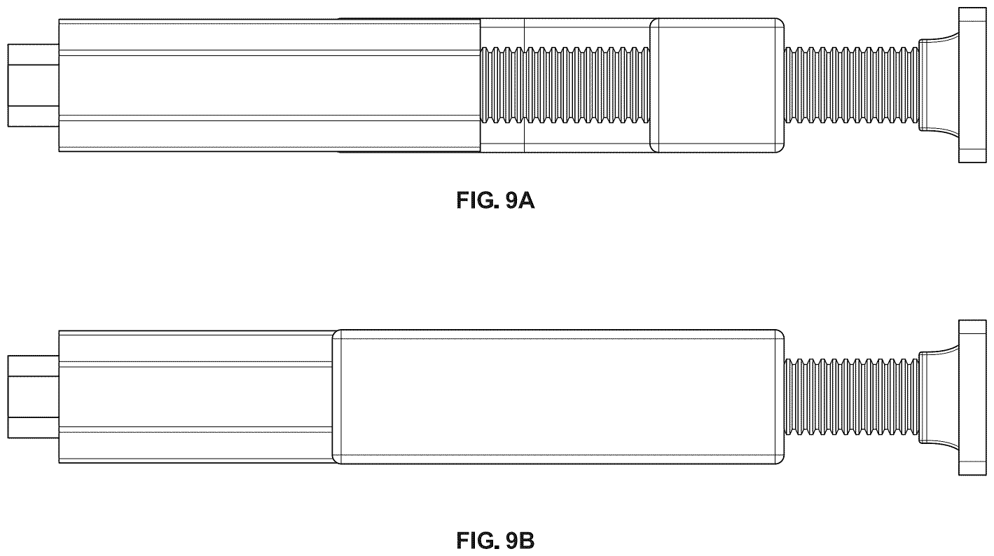

FIG. 9A is a top plan view of the clamp of FIG. 6.

FIG. 9B is a bottom plan view of the clamp of FIG. 6.

FIG. 10 illustrates how the clamp can be attached to a framing such as a half-slotted strut.

FIG. 11 shows the snap-in pad and how it can be used to cover an opening of the threaded bore.

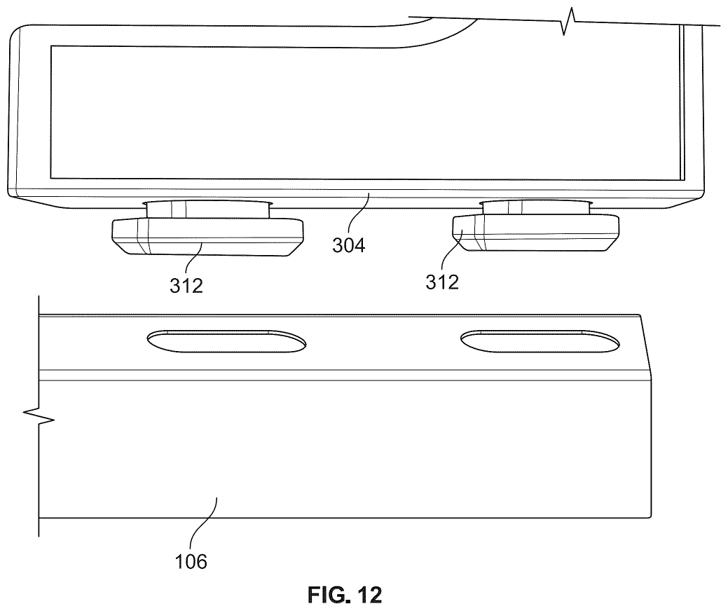

FIG. 12 shows the cleated feet of the clamp and how they can be inserted into corresponding openings in a surface of the half-slotted strut in order to attach the clamp to the half-slotted strut.

It should be understood that the foregoing description is only illustrative of the invention. Various alternatives and modifications can be devised by those skilled in the art without departing from the spirit of the invention. Accordingly, the present invention is intended to embrace all such alternatives, modifications and variances which fall within the scope of the appended claims.

What is claimed is:

1. A modular clamp system comprising at least one clamp comprising:
an L-shaped clamp body having:
a first leg,
and a second leg,
wherein the first leg includes a threaded bore extending therethrough,
proximate an end of said first leg, and the second leg includes a threaded channel in which a spring loaded retractable pin is retained,
a handle assembly comprising:
a threaded rod;
a hex handle extending longitudinally over a segment of said threaded rod;
a hex cap attached to a terminal end of the threaded rod, adjacent to said handle; and
a removable end pad at an opposite end from said hex cap; and
a pair of spaced apart cleated feet extending from a base of said clamp body, wherein said cleated feet are disposed on opposite sides of said base,
wherein the threaded bore is configured to receive the threaded rod of the handle assembly which rotatably engages said threaded bore and advances or retracts through the bore upon being rotated therein.

2. The modular clamp system of claim 1, wherein a cap is inserted into the threaded bore instead of the handle assembly, such that the cap covers an opening of the threaded bore.

3. The modular clamp system of claim 1, wherein the hex handle is threaded onto the threaded rod.

4. The modular clamp system of claim 1, wherein the hex handle has a hexagonal cross-section.

5. The modular clamp system of claim 1, wherein the hex handle extends over approximately half of the threaded rod.

6. The modular clamp system of claim 1, further comprising a set screw, wherein the set screw compresses a spring of the spring loaded pin when the set screw is screwed into the threaded opening.

7. The modular clamp system of claim 1, wherein the removable end pad snaps onto an end of the threaded rod.

8. The modular clamp system of claim 1, wherein the removable end pad has a flat surface configured to press against a surface of a workpiece.

9. The modular clamp system of claim 1, wherein each of the cleated feet include a flanged portion.

10. The modular clamp system of claim 6, wherein the clamp is secured to a half-slotted strut channel by:
inserting the cleated feet into corresponding openings in a surface of the half-slotted strut, such that the flanged portion extends/hooks under an opposite side surface of the half-slotted strut, and
rotating the set screw in the threaded opening thereby causing the spring loaded pin to be compressed against the surface of the half-slotted strut.

11. The modular clamp system of claim 1, wherein the end pad comprises a means of securing a workpiece.

12. The modular clamp system of claim 1, wherein said at least one clamp comprises a live-end and a dead-end, wherein the live-end is positioned adjacent to the dead-end such that the live-end and dead-end mirror each other, wherein a workpiece is secured by trapping the workpiece between the end pad of the handle assembly of the live-end and the pad covering the threaded bore of the dead-end.

13. The modular clamp system of claim 1, wherein said at least one clamp comprises a live-end and a dead-end, wherein the live-end is positioned adjacent to the dead-end such that the end pads of the respective handle assemblies of said live-end and dead-end oppose each other, wherein the live-end and dead-end grip a workpiece by advancing their respective handle assemblies until the end pads of each handle assembly firmly press against the workpiece, thereby trapping the workpiece between them.

14. The modular clamp system of claim 13, wherein the respective handle assemblies of said first and second clamps are coplanar.

15. The modular clamp system of claim 14, wherein the live-end and dead-end are attached to a half-slotted strut.

16. The modular clamp system of claim 1, wherein a plurality of said at least one clamp are attached to one or more half-slotted strut channels.

17. A method of using a modular clamp system to clamp a workpiece comprising the steps of:
attaching at least one clamp to a half-slotted strut, the clamp comprising:
an L-shaped clamp body having:
a first leg, and
a second leg,
wherein the first leg includes a threaded bore extending therethrough, proximate an end of said first leg, and the second leg includes a threaded opening in which a spring loaded retractable pin is retained,
a handle assembly comprising:
a threaded rod;
a hex handle extending longitudinally over a segment of said threaded rod;
a hex cap attached to a terminal end of the threaded rod,
adjacent to said handle; and
a removable end pad at an opposite end from said hex cap; and a pair of spaced apart cleated feet extending from a base of said clamp body,
wherein said cleated feet are disposed on opposite sides of said base,
wherein the threaded bore is configured to receive the threaded rod of the handle assembly which rotatably engages with said threaded bore and advances or retracts through said bore upon being rotated therein;
advancing the handle assembly through the threaded bore by rotating the hex handle until the end pad engages a surface of a workpiece;
firmly pressing the workpiece between the end pad and an opposing end pad of a second clamp or an opposing fixed surface, thereby trapping the workpiece between the opposing end pads or between the end pad and the opposing fixed surface.

18. The method of claim 17, wherein the handle assembly is rotated by a drill by connecting the drill to the hex cap and operating the drill.

19. The method of claim 17, wherein the at least one clamp is secured to a half-slotted strut by:
inserting the cleated feet into corresponding openings in the half-slotted strut and hooking the cleated feet under an opposite side surface of the half-slotted strut;
and rotating a set screw in the threaded opening thereby compressing the spring loaded pin against a surface of the half-slotted strut.
